(19) United States
(12) Patent Application Publication
(10) Pub. No.: US 2005/0170147 A1
(43) Pub. Date: Aug. 4, 2005

(54) Compressed, embossed, and molded nylon fiber composites that provide exceptionally hard substitutes for wood

(76) Inventors: Forrest C. Bacon, Conyers, GA (US); Wendell R. Holland, Conyers, GA (US)

Correspondence Address: Patrick D. Kelly, 11939 Manchester #403, St. Louis, MO, 63131, US

(21) Appl. No.: 10/438,033

(22) Filed: May 13, 2003

Related U.S. Application Data
(63) Continuation-in-part of application No. 10/284,598, filed on Oct. 31, 2002.
Application No. 10/284,598 is a continuation-in-part of application No. PCT/US01/11895, filed on Apr. 11, 2001.
(60) Provisional application No. 60/379,996, filed on May 13, 2002.

(51) Int. Cl. B32B 3/00

(52) U.S. Cl. 428/172; 428/475.5; 428/297.4

(57) ABSTRACT

Exceptionally hard and durable synthetic wood substitutes are disclosed, for uses such as waterproof substitutes for hardwoods. These hardened composites can be made by using heat and pressure to treat synthetic fiber composites made from fiber mats. Pieces are then cut from a large sheet of plywood-like material, and a suitable time-temperature-pressure combination is used to compress the pieces to a higher level of hardness, which can match or surpass hardwoods and approach ceramic levels. This two-step method is economical, and avoids any need to sustain exceptionally high pressures in a press that is large enough to generate entire sheets. In an alternate embodiment, sheets or pieces can be embossed with non-planar surfaces if desired, by passing them through a suitable type of press, such as a rolling cylinder press. These types of waterproof embossed sheets can be used as adhesive backer boards, to provide attractive and decorative panels or planks that can provide wood-grained or other desired patterns for siding use, and for various other purposes. Alternately, the embossing pattern can provide flow channels, to handle drainage, seepage, uwanted moisture, or other problems relating to water or other liquids or gases. For example, these types of embossed flow channels can allow a sheet with this design to be laid, channel side down, on top of freshly-poured concrete that has not yet fully cured and dried, to enable faster resumption of construction activities while the concrete cures fully over a span of weeks.

### RELATED APPLICATIONS

This application is a continuation-in-part of U.S. utility application Ser. No. 10/284,598, filed on Oct. 31, 2002, which in turn claimed priority based on Patent Cooperation Treaty application PCT/US01/11895, published as WO 01/76869, which had an international filing date of 11 Apr. 2001.

This application also claims the benefit, under 35 USC 120(e), of provisional patent application No. 60/379,996, filed on May 13, 2002.

### FIELD OF THE INVENTION

This invention is in the field of building materials, and relates to compressed and/or embossed panels, strips, and other items made from composite materials containing nylon fibers.

### BACKGROUND OF THE INVENTION

PCT application WO 01/76869 (Bacon et al) describes a method for making synthetic materials that contain nylon fibers, and that have stiffness and handling traits that enable them to function as waterproof and bug-proof substitutes for “sheetwood” materials, such as plywood, particle board, and oriented strand board (OSB).

This method of manufacture uses, as an intermediate in the process of manufacturing, a type of flexible fibrous mat referred to herein as a needle-punched mat. Although needle-punched mats are not the only types of flexible fibrous mats that can be used to make synthetic sheetwood substitutes as described herein, they tend to have better cohesive and tensile strength than other types of fiber mats (such as “bat-formed” or “air-laid” fiber mats). This improved cohesion and strength, in needle-punched mats, is generated by the increased degree of fiber intertwining that is created within such mats, by the needle-punching process. Accordingly, needle-punched mats are discussed herein as a preferred intermediate, which can be used to manufacture the compressed and embossed materials disclosed herein. However, it should be kept in mind that other types of fiber mats (such as bat-formed or air-laid mats) can be used, if desired, to create various grades of compressed and embossed materials that will be suitable for various uses as disclosed herein.

Roughly a dozen facilities located in various sites across America currently make needle-punched mats from discarded carpet segments. The steps used in most of those facilities can be summarized as follows:

1. Discarded carpet segments are shredded, to create a rough yarn mass. The carpet segments used as feedstock in this process are divided into two main categories: (i) post-industrial waste, which includes manufacturing waste, quality rejects, edge trimmings, unsold rolls, and other pieces of carpet that were never installed on a floor and walked on; and, (2) post-consumer carpet, which includes any piece of carpet that was installed on a floor and walked on, before being pulled up and discarded.

2. The rough yarn mass from the shredded carpet segments is pulled open and combed by a needle-cylinder machine, to create an open and fluffy mass of fibers, containing mostly nylon (from the carpet tufts) with some polypropylene (from the carpet backing). Some facilities blend these fibers with other types of fibers, such as fibers made by shredding discarded clothing or other textiles.

3. The mass of fibers is combed in a manner that forms a continuous ribbon, usually about 2 to 4 feet wide. This continuous ribbon is then laid down on a large slow-moving conveyor system, by a machine called a cross-lapper. A cross-lapper machine has a “head” that travels continuously, back and forth, along a set of rails that are mounted transversely above the slow-moving conveyor. As the “head” moves back and forth along its rails, driven by a chain or belt system, it lays down its continuous wide ribbon of combed nylon fibers, on top of the slow-moving conveyor. Instead of being a continuous smooth belt, the conveyor typically is made of parallel wooden slats, to allow debris (such as dirt and latex particles) to fall between the slats and be collected.

In most facilities, the conveyor system is about 13 feet wide, so that after the side edges of a mat are trimmed off by cutting blades, the final mat will be exactly 12 feet wide, to match a typical roll of carpet (measurements in the American carpet and lumber industries have not converted to metric units, and are expressed in feet and inches; those standard units are used in this application, and can be converted to metric units by the well-known conversion factors, 1 inch=2.54 cm, and 1 foot=0.305 meters; accordingly, carpet rolls that are 12 feet wide are about 3.66 meters wide). In most systems observed by the Inventors to date, four cross-lapper machines have been used, to allow the conveyor system to move forward at a reasonable and economical speed; if only three cross-lapper systems are used, the conveyor must move more slowly, to obtain uniform coverage by the three ribbons.

4. By the time all of the cross-lapping machines have deposited their thick ribbons of combed fibers on top of the conveyor, the pile of loose and fluffy fibers is roughly 12 to 15 inches thick, and it covers nearly the entire 13-foot width of the conveyor.

5. This thick and fluffy layer of fibers is then compressed, by rollers, to a mat that is about ½″ thick.

6. The compressed mat is then run through a needle-punch machine. In this machine, steel plates that extend across the entire width of the mat hold thousands of long needles, which point downward. These plates, and their needles, are hammered against the mat about 5 times per second, as the mat is slowly pulled through the punching zone. Each needle has a dozen or so nicks or barbs along the surface of its shaft, and each nick or barb can catch fiber strands and pull them downward or upward through the mat.

As a result of the cross-lapping operation, most of the fibers in the mat are laid down horizontally, on top of the conveyor. However, during the needle-punching operation, thousands of fibers per square yard are yanked vertically, both downward and upward, into and through the mat. These vertical fibers hold the mat together, in a fairly tight and cohesive but flexible manner, without requiring any chemical adhesives.

As a result, a typical mat which emerges from a needle-punch machine resembles an extra-thick blanket, containing hundreds of thousands (or even millions) of short but densely intertwined fiber strands per square yard. Depending on how thickly the large ribbons of combed fibers were laid down on top of the conveyor system by the cross-lappers, needle-punched mats can be made having thicknesses ranging from about 1/4 inch up to about 3/4 inch. Mats having differing thicknesses (and/or densities) are often referred to by “ounce” designations; for example, a “22 ounce mat” will weigh 22 ounces per square yard, and usually will be about 1/4 inch thick, while a 54 ounce mat will weigh 54 ounces per square yard, and usually will be about 9/16 inch thick.

As a mat emerges from a needle-punch machine, the side edges (which tend to be somewhat ragged) are cut off, usually by a rotating knife blade that interacts with an anvil in a manner comparable to scissors. This trimming operation will form side edges that are even, square, and blunt. Any number of these types of blades can be used, to create mats ranging from about 2 feet wide, up to 12 feet wide.

A mat which is 6 or 12 feet wide is usually rolled onto a heavy cardboard or plastic cylindrical spool, which typically holds a 50 or 100 foot length, depending on the thickness of the mat. When a spool is full, a travelling knife blade makes a transverse cut, across the width of the mat. The newly-cut end of the roll is taped or wrapped up, and the roll is sent to inventory, while an empty spool cylinder is moved into place to begin receiving the next length of needle-punched mat. These types of rolls are used most commonly for carpet installations.

Mats narrower than 6 feet wide are usually cut into short lengths, to form rectangles rather than rolls. These rectangles typically range from about 2 to 4 feet in width, and about 2 to 4 feet in length. They usually are stacked flat, to form bundles (or bales, etc.). A typical bundle usually contains about 20 to about 50 mats, all having the same rectangular dimensions, held together by tape, cords, straps, plastic film, or any other suitable tensile material. These mats are used mainly in the automotive industry, since they are inexpensive but can provide good thermal and noise insulation, in car trunks and various other locations.

Needle-punched mats have been available for many years. They have excellent durability; unlike foam or rubberized carpet pads, they will not flatten significantly even after years of heavy foot traffic. In addition, they provide very good thermal insulation and sound-deadening effects. Therefore, needle-punched mats are usually installed beneath carpets in commercial locations, such as stores, offices, restaurants, and theaters. However, they are not popular for carpet installations in homes, due to their inability to provide the type of springy, bouncy, young-and-new feel that appeals to homeowners buying a new carpet. Therefore, since most carpets are installed in homes rather than commercial establishments, there is not a large demand for needle-punched mats made from shredded carpet segments.

Manufacture of Sheetwood Substitutes Using Needle-Punched Mats

Because of the thickness and density of needle-punched mats, no one prior to Bacon et al (PCT application WO 01/76869) was able to create effective and practical methods for using chemical adhesives to convert needle-punched mats into consistent and reliable substitutes for plywood or other sheetwood materials.

The most severe problems that were encountered in prior efforts (most of which were never described in any patents or other publications, because they did not succeed) was that, prior to the methods described in PCT application WO 01/76869, it was extremely difficult and not commercially and economically feasible to obtain the level of consistency, evenness, and uniformity that was necessary to provide a genuinely useful and desirable sheetwood substitute. Even a small irregular patch or “seam” in the penetration, density, consistency, or other traits of an adhesive that has been forced into a dense fibrous mat will render a large sheet of wood-like material severely defective, and unable to compete, economically and commercially, against materials such as standard plywood or oriented-strand board.

However, through extensive testing, Bacon et al figured out three different methods to prevent weak spots, seams, and other irregularities from forming, when certain classes of adhesives were embedded in needle-punched mats.

The first method involves the use of chemical adhesives that are created by mixing together two liquids that will release tiny gas bubbles (in a reaction process that is usually called “foaming”, and occasionally called “creaming”) when they chemically react. One example of such a gas-releasing two-component mixture is offered by the “foaming” subcategory of an important class of adhesives that are generally referred to as polyurethane adhesives, or as isocyanate-polyurethane (IC/PU) adhesives. These adhesives are well-known; they are manufactured by several large companies (including BASF and Bayer), and they are sold by numerous smaller companies that can be located through Internet websites such as www.polyurethane.web. Extensive technical information is publicly available on these compounds, and nearly any company that sells these types of adhesives will have one or more technical specialists or sales representatives who can help any purchaser select a particular mixture for any intended use.

In general, polyurethane adhesives are created by mixing a resin with a catalyst. The resin has the general formula HO—X—OH, where X is a variable that represents any organic component containing carbon atoms. Since a hydroxy group (—OH) coupled to a carbon atom creates an alcohol, this resin can be referred to as an alcohol resin, or as a “diol” (double-alcohol) resin, or as a “polyol” resin if 3 or more hydroxy groups are attached to carbons. The catalyst has at least one cyanate group (O═C═N—). To enable polymerization, most catalysts have at least two cyanate groups, which flank another organic group represented by the variable Y in the following formula: O═C═N—Y—N═C═O. When the catalyst reacts with the resin, the result is polyurethane, which has the general structure: 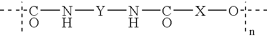
where n is a large number that represents the average number of “monomer” units that were linked together to form polymerized molecules.

Three aspects of the resin and catalyst reagents should be noted:

(1) The “X” variable, in the resin, can be a branched group, with additional hydroxy groups at the tips of some or all of the branches. If a branched resin having multiple hydroxy groups is used, it will create much more complex branched and interlocking molecular matrices than can be achieved by merely linear molecules (these types of resins are often referred to as “polyol” resins, if they contain multiple alcohol groups). In addition, a branched resin can have entirely different types of reactive groups at the tips of some of the branches, thereby allowing that particular resin to undergo additional types of reactions with other types of molecules (such as extremely tight bindings with molecules of nylon, in a nylon fiber composite).

(2) The Y variable, in the cyanate catalyst, can also be a branched group, thereby allowing still more complex branched and interlocking molecular matrices, and offering still more ways that a polyurethane adhesive can be enabled to bind to certain types of substrates, such as nylon fibers. If the Y variable has any type of side chain, then the cyanate catalyst can be referred to as an “isocyanate” resin, since the “iso” prefix in chemistry generally indicates that a chemical group has been affixed to a center carbon atom in a chain that contains 3 or more carbon atoms.

(3) Blends of different resin components, and different catalyst components, can be mixed together. For example, to provide a means to help control and regulate the polymerization reaction, a blend of cyanate catalysts can be used, where most of the catalyst molecules will have two, three, or even more cyanate reactive groups at their ends, but some fraction of the catalyst molecules will have only a single cyanate reactive group. When a catalyst having only a single cyanate reactive group is incorporated into a polymeric chain that is being formed, it will truncate, terminate, and “cap” that end of that polymeric chain. In the same manner, a small percentage of resin molecules having only a single reactive group can be included in the resin mixture, to form similar terminating or “cap” groups at the ends of polymeric chains.

In view of the range of molecular, structural, and binding options they offer, cyanate-polyurethane adhesives are an extremely useful and adaptable class of adhesives. They offer a wide variety of molecular, binding, and performance options and traits, and they have been extensively developed by researchers and companies working in that field of chemistry.

If a suitable foaming mixture is selected and used to convert one or more needle-punched nylon fiber mats into a hardened wood-like sheet product, the cyanate catalyst will be mixed with the alcohol resin, immediately before the mixture is contacted with the fiber mat(s). This can be done by various mechanical means, such as by using a mixing nozzle, mounted on a reciprocating holder that travels back and forth along a rail system that spans the width of a conveyor system, to spread a bead of the cyanate-resin mixture across the surfaces of either or both of two fiber mats, immediately before they are pressed together between large compression rollers at the inlet of a large moving-belt press.

Roughly 10 seconds after the catalyst is mixed with the resin, the liquid mixture will undergo a foaming reaction, which releases gas bubbles that are very effective in driving the liquid, evenly and uniformly, throughout the entire thicknesses of two needle-punched mats that are being pressed against each other inside a press. The resulting polyurethane adhesive will harden sufficiently, within about 8 to 10 minutes, to allow the pressure to be released, and the adhesive will continue to cure and harden slightly over roughly another 24 hours. The pressures required are low enough to allow continuous processing inside a “moving belt” machine, rather than requiring heavy molds or presses that must use “batch processing” to make only 1 sheet at a time. In addition, the chemical reaction that forms the polyurethane adhesive is exothermic, and releases enough energy to minimize or eliminate any need to add additional heat to drive the reaction.

The second method discovered by Bacon et al involves the use of polypropylene, which is widely used in carpet backing layers. Many previous carpet recycling efforts (including efforts to extrude melted nylon into planks, for park benches and similar uses, and efforts to depolymerize nylon, to recover the caprolactam monomers used to manufacture nylon) had gone to great lengths, in an effort to remove as much polypropylene as possible from the nylon fibers, in order to make the recovered nylon as pure as possible. Bacon et al took the opposite approach; instead of trying to purify the nylon fibers, they looked for ways to leave in the polypropylene impurities and put them to good use.

Nylon is a polyamide compound; it contains nitrogen, it is relatively expensive, and the versions used to make carpet fibers (usually called nylon-6 and nylon-6,6) generally have melting temperatures in the range of about 5700 Fahrenheit. By contrast, polypropylene is a polyolefin compound; it contains no nitrogen, it is substantially less expensive than nylon, and the versions used in carpet backing layers generally have melting temperatures of only about 330° Fahrenheit. Therefore, polypropylene belongs to a category of plastics that are often called “low melt” plastics.

Instead of trying to remove the polypropylene from a yarn mass obtained by shredding carpets, Bacon et al developed ways to add even more polypropylene, until enough polypropylene was present to make it a useful adhesive, when a needle-punched mat containing sufficient polypropylene is heated to temperatures that will melt the polypropylene, but not the nylon. Their methods of polypropylene addition use either or both of two approaches. One method involves blending polypropylene fibers with the nylon fibers, upstream of the combing operation that created the wide ribbons of fluffy fibers that were cross-lapped onto the conveyor system, as described above. This method can be used to distribute, disseminate, and embed any desired quantity or ratio of polypropylene throughout the entire mass and thickness of fibers that are being laid on top of a conveyor system by cross-lapper machines. The second method involves feeding only polypropylene fibers to the final cross-lapping machine, in a series of cross-lapping machines that are laying their wide ribbons on top of a large conveyor. This method can be used to create a surface “skin” layer of polypropylene, on top of a needle-punched mat containing mostly nylon fibers beneath the skin layer.

The third method that has been identified by Bacon et al, to ensure consistent, uniform, and reliable dispersion of adhesive chemicals throughout the entire area and thickness of a sheetwood material made from needle-punched fiber mats, involves the use of heat-activated (which roughly translates into “meltable”) adhesives that are stored and handled in granular, flake, powdered, or other particulate form. These types of particulate adhesives can be distributed (or disseminated, embedded, etc.) in a fairly even manner, throughout the entire thickness of a fiber mat while it is being laid down by cross-lapper machines on a conveyor system. This can be accomplished by mounting two or more “shaker trays” or similar distributing devices above the conveyor system, in locations positioned between adjacent sets of rails that support the travelling cross-lapper heads. While the system is in operation, the shaker trays are provided with a steady supply of adhesive particulates, using any suitable delivery mechanism. The jostling, vibrating, or other motion of the trays will cause the particulates to steadily and gradually fall out of the tray, in a manner that causes them to be sprinkled in a fairly even manner across the fiber mat which is being formed on top of the conveyor system. Since the fibers are being laid across the conveyor in a fluffy apd uncompressed form, settling of the adhesive particulates throughout the loose matrix of fibers will occur, in a manner that will help disperse and distribute the layers of particulate adhesives in a more even and consistent manner, rather than creating sharply-delineated alternating layers of fibers and adhesives.

Using these methods, along with various enhancements that are obvious to those skilled in the art, synthetic sheetwood substitutes containing nylon or other fibers can be manufactured from needle-punched fiber mats (or from air-laid, bat-formed, or other types of fiber mats, as mentioned above).

Since most of the building materials described herein will benefit in various ways if they are waterproof or at least water-resistant, the fibers used to manufacture these materials preferably should be limited, at least in most cases, to hydrophobic synthetic materials (such as fibers obtained from carpets made with nylon tufting materials). Any fibers that are hydrophilic (including natural fibers such as cotton and wool, and synthetic fibers such as polyesters) generally should be avoided in making building materials.

The concerns over waterproof materials that apply to building materials have less relevance when describing materials used to build cabinets or furniture. However, even in those classes of materials, concerns over microbes and insects that may be able to live on cotton or wool fibers or other natural fibers still remain relevant. In addition, most types of polyester and other synthetic fibers that are produced in truly large quantities (as distinct from highly expensive specialty fibers, such as KEVLAR™, used in speciality locations such as bullet-proof vests) do not have the tensile strengths, high melting temperatures, and other traits that make nylon fibers highly useful and valuable in the types of converted and hardened materials discussed herein. Therefore, the fibrous feedstock that is preferred for use herein will be nylon fibers (either virgin, or recycled), which may include some quantity of polypropylene, if used as a meltable adhesive, or if present as a result of carpet shredding or other operations. Any operator that wishes to evaluate and use some other type or source of fibers can do so, based on his or her specific knowledge of: (i) the specific products that the operator or company wishes to manufacture, and, (ii) the constraints and expenses that may limit the sources and supplies of fibers that can be used as feedstocks for making these materials.

It also should be noted that any mixture or blend of nylon fibers made from either nylon-6 or nylon-6,6 (the two main classes of nylon fibers used to make carpets) can be used as disclosed herein, mixed together in any ratio. Despite their use of the same digit, those two different types of nylon have substantially different chemical structures. Those chemical differences created major problems in prior art recycling processes that were designed to either: (i) melt and extrude recycled nylon, in shapes that would have substantial mechanical strengths, or (ii) chemically break down nylon, to convert it back into its constituent monomers. By contrast, in needle-punched mats used to create sheetwood materials (as disclosed in PCT application WO 01/76869) or to create synthetic roofing materials as disclosed herein, the chemical differences between nylon-6 and nylon-6,6 do not pose any significant problems. Any blend with any ratio of nylon-6 and nylon-6,6 fibers can be used, without requiring any sorting or separating steps.

The materials formed by the processes discussed above resemble plywood, in terms of their stiffness and density, and their ability to be sawed, drilled, nailed, and otherwise handled and worked in ways that render them well-suited for use as building materials. They can be manufactured in sheets of any desired size; for example, a needle-punched mat that is originally formed with a width of about 12.6 feet, with somewhat ragged edges, can be cut into strips that are 8.3 and 4.3 feet wide, and both of those strips can be converted into hardened wood-like sheets that can have their edges trimmed to provide finished sheets exactly 4 feet wide by 8 feet long, the same size as standard plywood sheets. These nylon fiber composite sheets can be stacked, stored, and shipped on pallets designed for forklifting, in the same manner as conventional plywood or OSB. The main differences between these nylon fiber composite sheets, and actual plywood or OSB, is that the composite sheets are waterproof and bug-proof, provide better sound and thermal insulation that wood products, are substantially stronger than wood products, and are more resistant to catching fire, if heated to high temperatures. In addition, they also are made from recycled waste products, and do not require any trees to be cut down. For all of these reasons, these synthetic sheetwood substitutes appear to offer building materials that are ideal for a wide range of uses, including indoor uses, outdoor uses, and even marine uses.

However, there are a number of specialized “niches” in the building, cabinet-making, and furniture-making industries, that cannot be adequately satisfied by plywood or OSB, or by a building material that provides a synthetic version of plywood or OSB.

As one example, hardwoods (such as oak, mahogany, hickory, etc.) have a number of traits, advantages, and uses that cannot be achieved by softwoods, by plywood or OSB, or by a synthetic substitute that is made in large sheets that emulate plywood or OSB.

Accordingly, there are a number of specialized needs and uses that would be well-suited for planks, boards, or devices made of synthetic composites that have been treated to render them harder and stiffer than plywood and OSB substitutes that can be made as described above. As one example from the realm of home construction, door thresholds are frequently and repeatedly stepped on, often with the full weight of heavy adults, and they often become wet, when people walk in during a rainstorm or under similar conditions. Therefore, if completely waterproof and exceptionally hard door thresholds could be made from nylon fiber composites, they could offer highly useful and valuable improvements over wooden door thresholds.

Other examples of items that require unusually high levels of hardness and strength include: (1) transition boards that are installed at the boundary between two different floor-covering types or heights; (2) stairs that must support balusters and banisters; (3) door or window frame components that must hold hinges or bear other types of loads, (4) various components of cabinets, such as cabinet doors, and the vertical strips next to cabinet door openings, both of which must absorb the impacts when people slam a cabinet door shut; and (5) various components of furniture, which are structurally important but which are not readily visible. Those are just a few illustrative examples, and numerous others will be recognized by those skilled in the art.

There also are a number of specialized needs and uses that would be well-suited for sheets of materials that have been treated to give them embossed, non-planar surfaces. As one example, “backer boards” with non-planar surfaces (usually with squares or diamonds that are depressed about 1/16 to ⅛ of an inch) can provide a substantially better “grip” for a layer of adhesive that will support paneling or veneer, or a surface layer of ceramic tiles.

As another example, if embossed sheets that are strong, waterproof, and durable could be provided with drainage channels that would allow them to handle seepage, drainage, or other moisture problems in convenient ways, they would become useful for a variety of purposes.

As yet another example, if sheets that are strong, waterproof, and durable could be embossed in ways that would render them attractive for siding or other decorative purposes (such as for house sidings that are both decorative and protective, and that provide improved levels of waterproofing, and that can be painted in any color), those also would be highly useful and valuable.

Accordingly, one object of this invention is to disclose strips of hardened synthetic wood-like materials, that can be used for building needs where an unusually high level of hardness would be advantageous, such as door thresholds, flooring transition strips, door and window frame or casing components that must support hinges, and stairs that must support balusters.

Another object of this invention is to disclose strips of unusually hard synthetic wood-like materials, that can be used for making components of cabinets, furniture, or other items that are conventionally made of wood.

Another object of this invention is to disclose strips of wood-like materials made from nylon fiber composites, that have exceptionally high strength and durability.

Another object of this invention is to disclose a method for making synthetic wood substitutes, in a manner that uses heat and pressure to provide the resulting materials with increased strength, hardness, and durability.

Another object of this invention is to disclose a method for making synthetic wood substitutes, in a manner that uses a second-stage compressing operation on component shaving limited sizes, to generate levels of compression and hardness that cannot be achieved economically in a large press designed to manufacture entire sheets.

Another object of this invention is to disclose a method for making synthetic wood substitutes, in a manner that uses heat and pressure to provide the wood substitutes with useful embossed surfaces.

Another object of this invention is to disclose a method for making synthetic wood substitutes that have been molded or embossed, to provide them with non-planar shapes, structures, or surfaces.

Another object of this invention is to disclose a method for making synthetic wood substitutes that have been molded or embossed, to provide waterproof articles that can be used for purposes such as adhesive backer boards, sheets with continuous channels that can enable improved moisture handling, and sheets or planks that have surface patterns that render the sheets or planks attractive as siding or decorative materials.

These and other objects of the invention will become more apparent through the following summary, drawings, and detailed description.

### SUMMARY OF THE INVENTION

Exceptionally hard and durable synthetic wood substitutes are disclosed, for uses such as waterproof substitutes for hardwoods. These hardened composites can be made by using heat and pressure to treat synthetic fiber composites made from fiber mats. In a preferred embodiment, large sheets are manufactured from needle-punched mats containing nylon fibers from shredded recycled carpets, using foaming cyanate-alcohol reagents to create non-rigid, non-brittle polyurethane adhesives that will cure to a hardness comparable to soft wood. Pieces are then cut from the large sheets, and a suitable time-temperature-pressure combination is used to compress the pieces to a substantially higher level of hardness, which can match or surpass hardwoods and approach ceramic levels. This two-step method is economical, and avoids any need to sustain exceptionally high pressures in a press that is large enough to generate entire sheets.

In an alternate embodiment, large sheets can be hardened, and embossed with non-planar surfaces if desired, by passing them through a suitable type of press, such as a rolling cylinder press. These types of waterproof embossed sheets can be used as adhesive backer boards, to provide attractive and decorative panels or planks that can provide wood-grained or other desired patterns for siding use, and for various other purposes. Alternately, the embossing pattern can provide flow channels, to handle drainage, seepage, uwanted moisture, or other problems relating to water or other liquids or gases. For example, these types of embossed flow channels can allow a sheet with this design to be laid, channel side down, on top of freshly-poured concrete that has not yet fully cured and dried, to enable faster resumption of construction activities while the concrete cures fully over a span of weeks.

### BRIEF DESCRIPTION OF THE DRAWINGS

FIG. 1 depicts a hardened strip, made from a strip of semi-hard nylon fiber composite material that was initially manufactured as part of a sheet, using foaming alcohol-cyanate reagents to create polyurethane, or using a heat-activated particulate adhesive. After the semi-hard sheet was sawed into strips, this strip was treated by heat and pressure, to compress it into a hardened strip, which was then treated by a router blade and sanding, to give it rounded edges so it can serve comfortably as a door threshold.

FIG. 2 depicts a segment of a flooring transition strip, which can provide a comfortable rounded surface between two adjacent rooms having floors with slightly different heights.

FIG. 3 depicts a segment of a thick and stiff adhesive backer board with depressed (sunken) squares, to support ceramic tiles or other heavy surfacing materials.

FIG. 4 depicts an embossed sheet that has continuous channel depressions, which can serve as moisture escape channels if this sheet is laid on top of freshly-poured concrete that has not yet fully cured and dried.

### DETAILED DESCRIPTION

As summarized above, this invention relates to compressed and/or embossed wood-like building materials made of composites that contain synthetic fibers, such as nylon fibers.

The materials of this invention can best be understood by comparing them to the large flat sheets of synthetic fiber composites that can be made by methods such as described in PCT application WO 01/76869 (Bacon et al), which is incorporated herein by reference. As summarized in the Background section, those methods use a large press to generate large sheets that are comparable to plywood, both in size, and in hardness.

The materials disclosed herein have either or both of two distinguishing traits: (1) they are significantly harder than the large plywood-like sheets mentioned above; and/or, (2) they have non-planar embossed or molded surfaces, which provide them with additional uses.

Both of these classes of materials are manufactured by processes that require very high pressures, i.e., pressure levels that cannot be generated and sustained, economically and practically, within a large press such as a moving-belt press designed to manufacture sheets of synthetic composite materials (except, perhaps, in an extremely large press that would require very large up-front investments and high operating costs).

Accordingly, the disclosures herein relate to machines and methods that can provide practical and economical means for mass-manufacturing synthetic fiber composites that are embossed, and/or that have hardnesses that match or surpass hardwoods, and that in some cases can approach the hardness of ceramics.

In the same way that a hardwood board or plank (such as oak, hickory, mahogany, etc.) has advantages and uses that cannot be matched by softwood or plywood, these hardened synthetic composites can provide advantages and uses that cannot be matched, either by softer wood-like synthetic materials (since they do not have the proper hardness and durability for certain uses), or by natural hardwoods (since they are not waterproof, bug-proof, etc.).

These hardened synthetic composites can be sawed, sanded, milled, machined, grooved, painted, and otherwise handled and worked in ways that are directly comparable to hardwood. They are waterproof; indeed, because of their additional compaction and density, they tend to be even more waterproof than large sheets of plywood-like materials that have not been compressed to achieve higher levels of hardness. They can securely hold nails or screws, even in locations that are closer to an end or side edge than can be tolerated by wood without splitting. And, since they are synthetic and cannot be eaten by termites, they can be constructed into buildings in ways that place these materials directly in contact with soil and mud. In addition, these ccomposite materials are also free of any grain structure, as occurs in wood. This means that they will not suffer from splintering, and they are less subject to cracking than wood.

Accordingly, these materials offer highly valuable combinations of traits and advantages, and they can be used in numerous locations where expensive hardwoods were previously preferred. Examples of such locations and uses that do not require embossed surfaces, in building and construction, include but are not limited to door thresholds, flooring transition strips, stairs that must support balusters and banisters, and door or window frame components that must hold hinges or bear other types of loads. Numerous other locations arise in cabinets, furniture, and similar items that are commonly made of wood. These are just examples, and numerous other uses and locations for exceptionally hard but non-ceramic waterproof synthetic materials disclosed herein will be recognized by those skilled in the art.

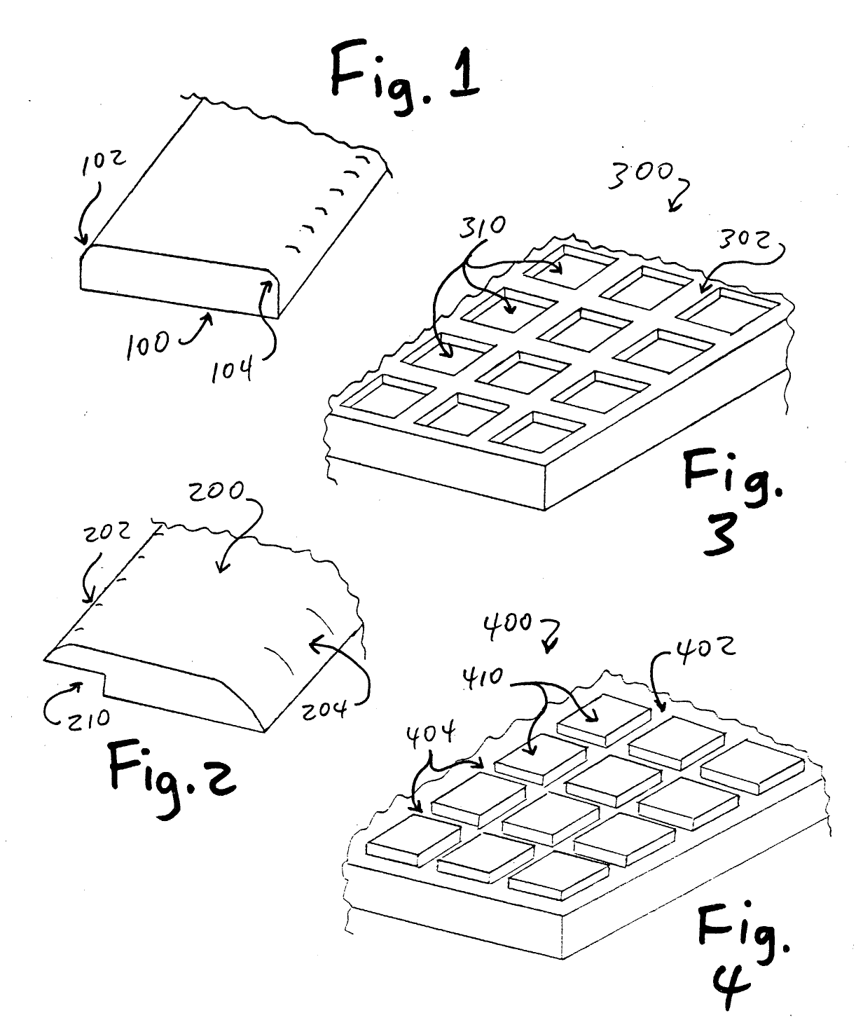

FIG. 1 illustrates a hardened and waterproof fiber composite wood substitute piece 100, in a shape and length that will render it suitable for use as a door threshold. The rounded edges 102 and 104, which will make it more comfortable to step on, can be created by any suitable woodworking method, such as by passing the strip between a fixed guide and a high-speed rotating router, dremel, or other bit, or other suitable milling tool that projects up out of a table surface. This can be followed by sanding if desired. Similarly, grooves can be cut into the surface of the piece 100.

FIG. 2 illustrates a flooring transition strip 200. This type of strip is provided with rounded edges 202 and 204 on its top side, and with a milled groove 210 on its bottom surface along one edge. This type of transition strip can be used to provide a smooth and comfortable transition between a linoleum, hardwood, or other flat floor surface, on one side of transition strip 200, and a carpeted surface having a different elevation, on the other side of the strip 200.

These are just two non-limiting examples of items that can benefit from being exceptionally hard, waterproof, and lacking in elongated “grain” structures of the type that often provides starting points for cracking or splintering.

EMBOSSED MATERIALS

Embossed materials that have controlled shapes, textures, and patterns in their surfaces can also be made by the compression methods disclosed herein, and they offer a variety of uses and benefits. As one example, “backer boards” with non-planar surfaces (usually with squares or diamonds, that typically are depressed about 1/16 to ⅛ of an inch) can provide a substantially better “grip” for a layer of adhesive that will support paneling or veneer, a surface layer of ceramic tiles, or other comparable items.

Backer boards made of relatively thin layers of nylon composites have alread been developed, by companies such as Innovations Inc (Atlanta, Ga.; www.ny-core.com). These types of relatively thin and lightweight backer boards may be able to provide support for lightweight surfaces, such as wood paneling; however, many types of ceramic tiles (such as used in bathrooms and kitchens) and other heavier surfacing materials may suffer from eventual cracking, after a span of years, if affixed by adhesive to a thin backing layer that may flex or warp, due to repeated heating and cooling, as the seasons progress through a decade or more. Therefore, backer board layers that are substantially thicker, harder, heavier, and stiffer (and that also provide better thermal insulation, if placed on an exterior wall, and better sound insulation on any wall) are disclosed herein. One such relatively thick and highly durable backer board 300 is illustrated in FIG. 3, having a “main” (or “grid”) surface 302, and an array of embossed or molded depressed (sunken) squares 310.

As another example, if embossed sheets that are strong, waterproof, and durable could be provided with drainage channels that would allow them to handle seepage, drainage, or other moisture problems (or other liquid or gas transfer or escape problems) in convenient ways, they would become useful for a variety of purposes. For example, these types of embossed flow channels can allow a sheet with this design to be laid, channel side down, on top of freshly-poured concrete that has not yet fully cured and dried. This can enable faster resumption of construction activities, and it can allow the concrete to cure fully over a span of weeks, thereby resulting in a better and stronger layer of concrete.

This type of embossed drainage and seepage board 400 is shown in FIG. 4. In this board, the “main” (or “grid”) surface 402 provides drainage channels 404, which are separated from each other by protruding squares 410. If placed with the embossed surface down, board 400 can be laid on top of freshly-poured concrete, as described above, and manifold-type devices can even be provided, along any exposed side edges of these boards 400, to actively blow or suction dry air through the channels 404, either continuously or intermittently, to speed up the final curing and hardening of the concrete. Alternately, if placed with the embossed surface down, board 400 can provide a waterproof high-traction drainage material that can be laid in any area that suffers from seepage, runoff, animal waste, or other problem relating to water or other liquids.

As yet another example, embossed sheets or planks that are strong, waterproof, and durable can be created, with wood-grained, strip-trimmed, or other decorative patterns that render them attractive for siding or other decorative purposes.

Methods of Manufacture

The volume of demand for exceptionally hard synthetic planks, boards, strips, or similar devices is not as great as the volume of demand for large sheets that can provide waterproof and bugproof substitutes for plywood or OSB. Therefore, it usually will not be practical or economical to use a large press to create relatively small quantities of extra-hard compressed planks, strips, or devices. Accordingly, a preferred method of manufacture involves using a smaller press (including, if desired, a batch press rather than a continuous press) to reach and sustain, for a suitable period of time, a temperature-pressure combination that will create an “extra-compressed” synthetic plank having a higher level of hardness than can be achieved in a large press.

This type of “extra-compression” step can be carried out during either of two times, during a manufacturing operation. In one embodiment, it can be performed when the liquid or granular adhesive is being cured and hardened, during the “main” curing step that is used to convert a flexible fiber mat into a hardened wood substitute. Rather than carrying out a “main curing step” to create a hardened wood substitute, and then subjecting the hardened wood substitute to an additional molding or compression process, a single curing step can be carried out, in a press that can create and sustain the desired temperature-pressure combination.

Alternately, since it may be difficult and expensive to create and operate a press that can handle an entire curing operation under exceptionally high temperatures and pressures, in another preferred embodiment, it has been discovered that various types of already-cured and hardened wood substitutes (including wood substitutes that were formed by using foaming reagents to create polyurethane adhesives) can be subjected to a second molding and/or compression operation. If made from suitable adhesives and properly treated, these already-formed synthetic composites will assume and adopt, readily and permanently, the new shape and/or thickness that is imparted to them by the second molding and/or compression operation.

These types of elevated pressures can be generated by any of several means. As one example, a large sheet of semi-hardened material (with a hardness comparable to a material such as pine or plywood) can be cut into smaller pieces, which can then be compressed in one or more small presses, mold cavities, or other devices that will generate high pressures.

As yet another example, a sheet of material having any desired width can be passed through a press that will generate high pressures only in a limited area (such as a rolling cylinder or drum press, which can be positioned at or near the outlet of a large moving-belt press, if desired, so that semi-hardened composite sheets can be compressed to higher levels of hardness, while still heated).

To convert a piece of nylon fiber composite having known hardness characteristics into a hardened piece that has a surface hardness comparable to oak or hickory, or even approaching the hardness of a ceramic, the person who wishes to do the conversion can create a set of time, temperature, and pressure graphs, which will require no more than routine experimentation. For example, a person can decide tha he or she will work with standardized strips of material, 10 inches wide and 15 inches long, that have been cut from a sheet of fiber composite material that has a known and fixed thickness (such as 5/8 inch), and that has already been semi-hardened, in a moving belt press, using a particular type of adhesive (such as a foaming isocyanate-polyurethane). The operator will begin the trials with a set of working assumptions about time periods; for example, he or she may decide to run a set of trials, using a 5 minute, 10 minute, or 15 minute heating and pressure cycle, on each test strip. Then, for each time period of interest, he or she will test a series of strips, using a fixed temperature and a series of escalating pressures (or, alternately, a fixed pressure and a series of escalating temperatures). The hardness of each strip can be evaluated, as it emerges from a particular time-temperature-pressure combination. This can be done using sophisticated equipment if desired, but it can also be done quickly and easily, by a simple “thumbnail” test. In this test, which can be surprisingly consistent and reliable, the edge of the thumbnail is pressed hard into the treated material, and the depth and width of the resulting indentation is then compared to similar marks (both along the grain, and across the grain) that were pressed by the same person, using the same thumb, into a piece of hardwood.

Similar simple and inexpensive tests can also be done, on a semi-quantitative basis, by using a weighted device (preferably weighing about 20 to 50 pounds) having a screw or nail point and/or a sharpened rounded edge (comparable to a thumbnail, and generated by grinding one edge of a steel washer into a sharp rounded edge, and then bending the washer so that the sharpened edge will protrude outward when the washer is nailed or screwed to the weight. The device with the protruding edge is placed on top of the treated strip, and allowed to rest on top of it for a fixed period of time (such as 30 or 60 seconds). This test can be repeated several times, on each side of the treated strip that is being tested. Then the depths and/or lengths of the indentations are evaluated, and compared to similar indentations on an identically treated piece of hardwood. These comparisons can be measured, using sophisticated instruments, or they can be “eyeballed”, to assess the size, depth, and/or length of the shadow in an indentation, under a bright light at a slanted angle.

Accordingly, a measured or estimated number for each such point can be determined, which can be expressed in terms of a percentage (either greater or less than 100%) of the comparable indentations on the hardwood. These numbers should be recorded in a table, and the time, temperature, and pressure parameters should be written directly on the treated sample, so that if any particular data point, when plotted on a graph, seems to fall outside of a valid curve, that particular data point can be visually reinspected, to make sure it was estimated in a consistent manner with the others.

The data from all of the temperature and pressure combinations that were prepared by using a fixed time (such as a 5 minute compression cycle) can be plotted on a single sheet of paper. Each of the data points generated by testing a series of pressures, at some fixed temperature, will be plotted together in a single curve, using the numerical percentage estimate that relates each data point to the hardwood indentation. After a complete curve has been plotted for all of the pressures that were tested at some particular temperature, then the data points will be plotted, for the next particular temperature. Accordingly, a set of curves is constructed, one by one, for a series of different temperatures, and each sheet of paper will contain all of the temperature-and-pressure curves, for some particular time period that was tested.

These types of informal and inexpensive tests can be used to determine a range of useful treatment parameters, for any particular starting material that is being used and treated at a certain manufacturing facility. Those ranges can then be used to select a preferred set of treatment conditions. In this manner, all necessary preliminary and preparative work can be handled quickly and inexpensively, so that when candidate samples must be sent out for precision testing, under the standards set by organizations such as ASTM (the American Society for Testing and Materials) or ANSI (the American National Standards Institute), the candidate samples will be very nearly optimized already, and total costs and delays can be minimized.

The ranges of treatment parameters will not be identical for all possible starting materials across an entire country, or between different countries or continents. However, any manufacturing or treating facility that purchases or manufactures sheets of plywood-like fiber composites will know the sources of its feedstocks, and it can take steps to require advance notification before the chemical content or performance traits of those feedstocks are altered in important ways.

Without asserting that this or any other particular combination of time, temperature, and pressure will work as desired for all such uses, the Applicants herein state and disclose that, when they were converting strips of semi-hardened plywood-like nylon fiber composites (prepared by using foaming isocyanate-polyurethane mixtures to penetrate needle-punched pads,) into hardened strips, the general range of parameters they found most useful, in small-scale batch-processing operations, used temperatures in the range of about 350 to about 450° F. (to ensure melting of any polypropylene in the composite material, while remaining comfortably below the melting temperatures of nylon), and pressures in the range of about 320 to 450 psi (gauge pressure), applied for periods that generally ranged from about 30 seconds up to about 10 minutes.

Thus, there has been shown and described a new and useful means for creating hardened and/or embossed materials made from nylon fiber composites. Although this invention has been exemplified for purposes of illustration and description by reference to certain specific embodiments, it will be apparent to those skilled in the art that various modifications, alterations, and equivalents of the illustrated examples are possible. Any such changes which derive directly from the teachings herein, and which do not depart from the spirit and scope of the invention, are deemed to be covered by this invention.

1. A segment of nylon fiber composite material having elevated hardness, wherein said elevated hardness was imparted to said segment by a heated compression operation on a piece of material from a sheet of wood-like material that was previously hardened in sheet form by curing an adhesive compound embedded within a fibrous matrix.

2. The segment of nylon fiber composite material of claim 1, wherein the heated compression operation is carried out at a temperature in a range of about 350° F. to about 450° F.

3. The segment of nylon fiber composite material of claim 1, wherein the heated compression operation is carried out at a pressure in a range of about 320 to about 450 pounds per square inch.

4. The segment of nylon fiber composite material of claim 1, wherein the segment has a cross-section shape that renders it suitable for use as a door threshold.

5. The segment of nylon fiber composite material of claim 1, wherein the segment has a cross-section shape that renders it suitable for use as a flooring transition strip.

6. The segment of nylon fiber composite material of claim 1, wherein the segment has at least one embossed surface.

7. The segment of nylon fiber composite material of claim 1, wherein the segment has at least one embossed surface that provides drainage channels that can be used to transfer a gas or liquid.
